(19) United States
(12) Patent Application Publication
(10) Pub. No.: US 2018/0012310 A1
(43) Pub. Date: Jan. 11, 2018

(54) CREATING AND EXECUTING A WELL CONSTRUCTION/OPERATION PLAN

(71) Applicant: Schlumberger Technology Corporation, Sugar Land, TX (US)

(72) Inventors: Maria Fox, Cambridge (GB); Derek Long, Cambridge (GB); Guillaume Tamboise, Katy, TX (US); Rustam Isangulov, Katy, TX (US)

(21) Appl. No.: 15/541,381

(22) PCT Filed: Jan. 6, 2016
(86) PCT No.: PCT/US2016/012254

§ 371 Date: Jul. 3, 2017

Related U.S. Application Data
(60) Provisional application No. 62/100,169, filed on Jan. 6, 2015.

(51) Int. Cl. G06Q 50/02; E21B 41/00; G06Q 10/06; E21B 44/00; E21B 19/00

(52) U.S. Cl. CPC G06Q 50/02; E21B 41/0092; G06Q 10/06313; E21B 19/00; E21B 44/00

(57) ABSTRACT

A plan structure and a method for creating a plan for forming/operating a sub-sea or sub-terranean well, in an automated planner, are disclosed. The plan defines logical, sequential and conditional interrelationships between events in the plan, so that a controller can carry out the plan in a flexible and time-independent manner to complete the sequenced events. The definition of the logical, sequential and conditional interdependencies permits flexibility in how the controller uses the time and resources available to it so that the plan directs the controller in a non-prescriptive manner, allowing greater flexibility in plan execution and reducing the necessity for re-planning to occur when changes in the world or environment in which the controller executes the plan are detected.

### CROSS REFERENCE PARAGRAPH

This application claims the benefit of U.S. Provisional Application No. 62/100,169, entitled “METHOD OF CREATING AND EXECUTING A PLAN,” filed Jan. 6, 2015, the disclosure of which is hereby incorporated herein by reference.

### BACKGROUND TO THE DISCLOSURE

The present disclosure relates to method for planning or executing a plan for an oilfield related activity. While the disclosure describes construction of a subterranean or sub-sea well as an example, the method may be used for other oilfield activities such as drilling procedures, hydraulic fracturing, hydrocarbon production, hydrocarbon exploration and/or the like.

The present disclosure relates in particular but not by way of limitation to the automated planning and/or execution of tasks in subterranean or sub-sea wells. In some aspects, the disclosure relates to improved methods of creating and/or executing automation plans for well forming equipment, such as for drilling equipment, cementing or completion equipment during an oil well drilling process, hydraulic fracturing, hydrocarbon production and/or other aspects of oilfield activities.

The process known as automated planning defines a framework to describe the physical world associated with a goal oriented activity. This is done through modelling a finite set of actions that can change the state of the world or environment in which an activity is being carried out. The state of the world and changes to the state of the world are detected and registered by a number of monitoring inputs to the system from sensors, for example.

Dynamic automated planning (“dynamic planning”) generally comprises choosing and scheduling a number of actions that will change the state of the world, or an environment in which the activity is being carried out, from an initial state to a goal state. Each action carried out to achieve the goal has an effect on a predetermined number of state variables, and can only be executed if a given set of conditions based on another predetermined number of state variables are met.

When an action is executed, if the action does not have the expected effect on the world, the plan is said to fail. Then a new plan is built starting from the new current initial state, which is the state reached after execution of the failed action.

For example, in the drilling domain, the action of drilling to the next connection in a drill string can take as a precondition that the drilling bit is on the bottom of the bore drilled so far, and can have as an effect on the world that the hole depth has increased by the length of a stand, since the last connection. A stand is a sub-section of drill piping from which the drill string is generally constructed in sections. A stand is generally a drill pipe section of a certain set length, ranging from around 10 metres or 30 feet, to around 30 metres or 90 feet.

Applied to the upstream oil and gas drilling domain, a drill-a-stand plan would get the world from an initial state, in which the string is in slips with a new portion of a drill pipe (stand) being above the stick-up point at the beginning of stand number n, to a goal state, in which the string is in slips with the same stand being below the stick-up point at the end of the drilling of stand number n.

Known planning technologies can lack flexibility and generally work in a prescriptive manner, such that the plan instructs a controller of a drilling system to carry out numbered actions in a predetermined order and in a predetermined time scale. If the end of each action does not result in an expected state of the world, then the plan is deemed to have failed and re-planning is necessary. Re-planning can be a time consuming and exercise, with re-planning times ranging from a few seconds to minutes, depending upon the complexity of the overall operation. Re-planning time taken up on a large and valuable drilling rig delays the overall drilling operation and can reduce efficiency and increase overall costs.

Known planning technologies generally pre-define plans without allowing flexibility in the plan for variations in real time constraints or conditions which can affect the world in which the plan is executed, but which are not specifically identified in the plan. If an unexpected condition takes the plan outside of its initially defined envelope of operation then the plan is deemed to have failed and re-planning occurs. Further, known planning technologies execute actions based upon a time elapsed during the execution of the plan, or at specific time steps in the execution of the plan.

### SUMMARY OF THE DISCLOSURE

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth.

The present disclosure seeks to overcome drawbacks of known planning techniques.

The present disclosure provides a method, carried out in an automated planner, of creating a plan for execution by a controller in the operation/construction of a subterranean or sub-sea well. Then plan provides for changing the well/the operation of or in the well from a first state to a goal state. The method is performed by defining a plurality of events in the plan which are to be carried out to change the state of the well from the first state to the goal state. The plan defines for one or more of the plurality of events a list of any events in the plan which must precede the event, an action to which the event relates, and at least one condition for the event, selected from: at least one authorising precondition; at least one confirming condition; and at least one failure condition.

The method may further comprise creating the plan while taking account of one or more input variables representative of user desires of one or more users of the automated planner. The user desires may relate to actions to be carried out in the construction/operation of the well. The one or more user desires may be allocated a weighting with respect to other inputs to the planner.

In some embodiments, all operations to be performed in the well must be submitted to the planner. This is contrary to current practice where individual operations in the well may be actioned independently. By requiring all operations in the well to be actioned through the well planner, the planner may optimize construction/operation of the well by determining a plan for each operation and by optimizing operating conditions to account for each and all of the desired operations, which may in practice require contrary operating conditions.

The planner may account for the user desires by changing the goal of the planner in response to the user desires. The weighting of the user desires may relate to a level of criticality of the desire to the well construction procedure.

Creating the plan may comprise incorporating input, relating to calculated parameters of the well construction procedure, received from one or more logically or physically separate processing modules.

The input taken from the separate processing modules may relate to physical parameters of the domain in which the well construction/operation is planned to occur.

The input taken from the separate processing modules may relate to one or more of: the calculation of depth markers for a steering command in a drilling operation; a calculation of an optimal weight on the drill bit for a desired rate of penetration; calculation of a pump rate for hydraulic fracturing; calculation of a pressure for managed pressure drilling; calculation of a flow rate for hydrocarbon production/calculating cement properties for a completion; calculating casing string properties for a casing operation; and/or the like.

The method may further comprise executing the plan, in a controller, to change a subterranean or sub-sea well from a first state to a goal state; and further comprising: incorporating input relating to calculated parameters of the well construction procedure/well operation procedure from one or more logically or physically separate processing modules during execution of the plan.

The method may further comprise selecting events for inclusion in the plan from a set of events, the set of events including pre-defined macros comprising pre-defined sets of events relating to the well construction/operation procedure.

A cost or reward function may be improved based upon the selection by the planner of one or more of the pre-defined macros.

The method may further comprise executing the plan, in a controller, to change a subterranean or sub-sea well from a first state to a goal state; and further comprising terminating the execution of the plan created by the automated planner and executing a pre-set plan to achieve a chosen goal without reference to the automated planner.

The pre-set plan may comprise events relating to actions normally used by the automated planner, wherein: one or more of: the list of any events in the plan which must precede the event; an action to which the event relates; and one or more of:
the at least one authorising precondition;
the at least one confirming condition; and
the at least one failure condition,
   is either removed or disregarded or is configured with adjusted parameters, to reduce its likelihood of causing the pre-set plan to fail.

In the method, the following steps may occur separately or in combination:
data relating to a time taken for the planning procedure to complete may be held in a memory; and
an external state of a system configured to execute the plan may be monitored during a planning step; and
a determination may be made as to whether to abort the planning step, based upon the data and a detection of a change in the external state of the system.

The data, preferably data relating to the time taken for the planning procedure to complete, may be based upon statistical analysis of previous performance of the planning procedure.

The data may comprise expected planning times relating to one or more of: one or more chosen goals and one or more initial states of the system.

The method may further comprise executing the created plan in a controller, to change a subterranean or sub-sea well from a first state to a goal state; and further comprising terminating execution of the plan on detection of a failure condition and recommencing one or more of the planning steps of the disclosure to establish a revised plan based upon a new initial state of the well.

In the method, audit data may be recorded for the plan creation procedure, the audit data comprising one or more of: an initial state, a goal and a resulting plan.

The audit data may be recorded for a plurality of planning and re-planning cycles during the execution of a well activity.

At least one of the conditions may be defined in relation to a predetermined expected time window.

The predetermined expected time window may be defined in relation to a preceding event in the plan.

The failure condition may be defined in relation to the predetermined time window.

At least one of the conditions may be defined in relation to a state based parameter.

The action or actions in the method may relate to a drilling operation and the first state may be a first drilling state and the goal state may be a second drilling state. In some aspects, actions may be desired operations in the well, such as hydraulic fracturing, managing pressure, cementing, lining the well and/or the like. In some embodiments, all such actions are entered into the planner and/or executed by the plan to provide for optimization of all actions/goals. For example, goals/actions may be given weightings so that the planner may plan for coordinating the goals/actions.

The goal state may relate to one or more stands in the drilling operation having been drilled.

The action or actions may be actions carried out in a well cementing process.

The action or actions may be actions carried out to operate equipment, deliver equipment to, or withdraw items from the well on a wireline.

The action or actions may be actions in a well completion process, including any of: casing insertion, cementing and/or well perforation

The action or actions may be actions in a hydraulic fracturing operation.

The action or actions may be actions in a managed pressure drilling operation.

At least one of the events in the plan may define a parameter for an action executed by the event.

The plan may further define a list of any successor events for at least one of the plurality of events in the plan.

The method may further comprise creating the plan using information in a domain data file defining the domain for the well construction/operation and incorporating into the plan control parameters for actions defined in the plan, based upon operational data taken from an operational data file.

The method may further comprise executing the plan in a controller to change the well from a first state to a goal state, by executing at least one of the plurality of actions defined in the plan, based upon a determination that any defined predecessor events for one or more events have been completed, and further comprising at least one of:
starting at least one action of the plan, independently of time, based upon a determination that a preauthorising condition has been met;
continuing at least one action in the plan based upon a continuous monitoring of whether the failure condition has been met; and
confirming that at least one action in the plan is complete, by a determination of whether the confirming condition has been met

The disclosure further provides a planning system, for creating a plan for execution by a controller in the construction of a sub-sea well, comprising an automated planner, the automated planner being configured to carry out one or more of the planning steps of the disclosure.

The disclosure further provides a system for use in the construction of a subterranean or sub-sea well, comprising a planning system and a controller configured to execute the plan to change the well from a first construction state to a goal construction state.

The disclosure further provides a computer program, or a suite of computer programs, comprising instructions which, when carried out by a processor of a computing device, cause the computing device to be configured to carry out the method according to one or more of the steps of the disclosure described herein.

The disclosure further provides a computer readable medium, comprising the computer program, or at least one of the suite of computer programs.

The disclosure further provides a plan defining a plurality of events to be carried out to change the state of a subterranean or sub-sea well from a first construction state to a goal construction state; the plan further defining, for one or more of the plurality of events:
a list of events in the plan which must precede the event;
an action to which the event relates; and
at least one condition for the event, selected from:
   at least one authorising precondition;
   at least one confirming condition; and
   at least one failure condition.

The disclosure can further provide a plan structure, and a method for executing a plan, for forming/operating a sub-sea or sub-terranean well. The plan may define logical, sequential and conditional interrelationships between events in the plan, so that a controller can carry out the plan in a flexible and time-independent manner to complete the sequenced events with minimal constraints. The definition of the logical, sequential and conditional interdependencies permits flexibility in how the controller uses time and resources available to it, so that the plan directs the controller in a non-prescriptive manner, allowing greater flexibility in plan execution and reducing the necessity for re-planning to occur when changes in the world or environment in which the controller executes the plan are detected.

In the present disclosure, an event can generally be associated with one action, or optionally with more than one action. An event generally relates to one or more of: the start of an action or actions to which the event relates; or the end of an action or actions to which the event relates. The start of an action can be instigated by a determination that a preauthorising condition has been met. This can be termed an authorising event. The end of an action can be confirmed by detection of a confirming condition, which confirms that the action has ceased or ended. This can be termed a confirming event.

The method of the disclosure may include executing a plan using a continuous model of time, so that, in place of prior art methods, in which discrete actions are scheduled based upon discrete timings and discrete criteria, the execution of actions in the method of the disclosure is controlled based upon continuous assessment and monitoring of changes affecting the start or continued execution of actions initiated during the carrying out of the plan. Working from a model of the drilling domain, modelled in a modelling language such as PDDL+, a plan used in the method of the disclosure is constructed automatically by a hybrid planning system. The plan of the disclosure allows for flexibility in the use of time or resources used to execute the plan, by use of its definitions of interdependencies and interrelationships between actions making up the plan and defined preconditions and failure conditions which may apply.

The disclosure can further provide a plan structure, and a method for executing a plan, for forming/operating a sub-sea or subterranean well. The plan defines logical, sequential and conditional interrelationships between events in the plan, so that a controller can carry out the plan in a flexible and time-independent manner to complete the sequenced events with minimal constraints. The definition of the logical, sequential and conditional interdependencies can permit flexibility in how the controller uses time and resources available to it, so that the plan directs the controller in a non-prescriptive manner, allowing greater flexibility in plan execution and reducing the necessity for re-planning to occur when changes in the world or environment in which the controller executes the plan are detected.

In the present disclosure, an event is generally associated with one action, or optionally with more than one action. An event generally relates to one or more of: the start of an action or actions to which the event relates; or the end of an action or actions to which the event relates. The start of an action can be instigated by a determination that a preauthorising condition has been met. This can be termed an authorising event. The end of an action can be confirmed by detection of a confirming condition, which confirms that the action has ceased or ended. This can be termed a confirming event.

The method of the disclosure may include execution of a plan using a continuous model of time, so that, in place of prior art methods, in which discrete actions are scheduled based upon discrete timings and discrete criteria, the execution of actions in the method of the disclosure is controlled based upon continuous assessment and monitoring of changes affecting the start or continued execution of actions initiated during the carrying out of the plan. Working from a model of the drilling domain, modelled in a modelling language such as PDDL+, a plan used in the method of the disclosure may be constructed automatically by a hybrid planning system. The plan of the disclosure allows for flexibility in the use of time or resources used to execute the plan, by use of its definitions of interdependencies and interrelationships between actions making up the plan and defined preconditions and failure conditions which may apply.

According to a further aspect of the disclosure there may be provided a method of construction of a subterranean or sub-sea well by executing a plan, in a controller, to change the well from a first construction state to a goal construction state;
the plan defining a plurality of events to be carried out to change the state of the well from the first construction state to the goal construction state; the plan further defining, for one or more of the plurality of events:
   a list of any events in the plan which must precede the event;
   an action to which the event relates; and
   at least one condition for the event, selected from:
      at least one authorising precondition;
      at least one confirming condition; and
      at least one failure condition;
the method comprising executing at least one of the plurality of actions defined in the plan, based upon a determination that any defined predecessor events for one or more events have been completed, and further comprising at least one of:
   starting at least one action of the plan, independently of time, based upon a determination that a preauthorising condition has been met;
   continuing at least one action in the plan based upon a continuous monitoring of whether the failure condition has been met; and
   confirming that at least one action in the plan is complete, by a determination of whether the confirming condition has been met.

The above method can allow an automated plan to be executed in a more robust manner, since variations in time taken to complete actions, and influences from factors not accounted for in the domain model, can be accommodated during execution without a need to initiate re-planning.

The method may further comprise starting a subsequent action based upon the confirmation that at least one action in the plan is complete.

At least one of the conditions may be defined in relation to a predetermined expected time window.

The time window may be defined in relation to a preceding event in the plan.

The failure condition may be defined in relation to the predetermined time window.

At least one of the conditions may be defined in relation to a state based parameter.

The action may be started in a case in which the state based parameter reaches a predefined state.

The action may be stopped in a case which the state based parameter reaches a predefined state.

The action may be stopped in a case in which the state based parameter indicates the absence of a predefined condition.

An execution of at least one action in the plan may be governed by a hybrid state, the hybrid state defined by a first variable being within a predetermined range of values, and a second, state based, variable being detected as being in a predetermined state.

The disclosure may further provide a system for constructing a subterranean or sub-sea well, comprising a controller, the controller being configured to carry out one or more method steps of the disclosure described herein.

Any or all of the above features of the disclosure can be combined, in any combination, to provide advantages which will become further apparent on reading the following detailed description.

### BRIEF DESCRIPTION OF THE DRAWINGS

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

FIG. 1 shows a well construction system in a first construction state;

FIG. 2 shows a well construction system in a second, goal, construction state;

FIG. 3 shows a first portion of a graphical representation of a plan of the disclosure;

FIG. 4 shows a second portion of a graphical representation of a plan according to the disclosure;

FIG. 5 shows a further portion of a graphical representation of a plan according to the disclosure;

FIG. 6 shows a further portion of a graphical representation of a plan according to the disclosure;

FIG. 7 shows a final portion of a graphical representation of a plan according to the disclosure;

FIG. 8 shows an apparatus for carrying out the method of the disclosure; and

FIG. 9 shows further apparatus for carrying out the method of the disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE DISCLOSURE

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

The planning system of the disclosure will now be described with reference to a specific example of a plan for drilling a stand during construction of an oil or gas well. As noted above, this is merely an example of one form of plan for an oilfield operation and the plan may comprise other oilfield operations in or affecting the well.

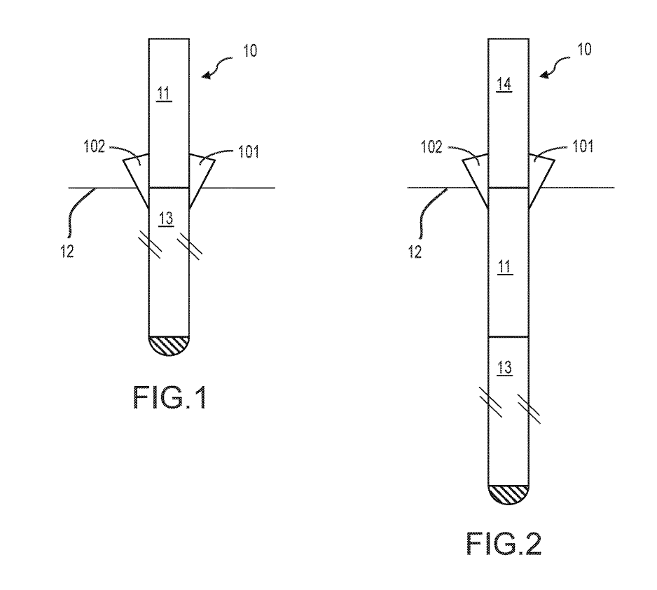

FIG. 1 shows a drilling system for carrying out the drilling step in a well construction process. However, the method of creating and executing a plan according to the disclosure can be applied to other aspects of well construction, such as cementing and completion operations and wireline operations, for example, by adaptation of the planning and execution methods described herein.

In FIG. 1 the drill string 10 is in slips 101 and 102 with a new portion of a drill pipe (stand) 11 being above the stick-up point 12, and a remainder of the string 13 being below the stick-up point 12.

FIG. 2 shows the string 10 now in a new state, where a stand has been drilled, the portion of drill pipe 11 is now below the stick-up point 12 and the string is once again held in slips with a further new portion of drill pipe 14 above the stick-up point. As is known to the skilled reader, numerous stands can be added to the drill string and can be sequentially drilled into the ground as the drill bit at the bottom of the string penetrates the ground and pumping systems can be used to circulate mud to bring shale fragments and earth up from the drill head. A drill bit wears as it is used to drill into the ground and so will need to be replaced periodically. Models can be created based upon calculations and/or empirical data, defining a rate of drill bit wear for a given rate of penetration of the drill bit into certain types of ground. This allows a planner of a drilling operation to know approximately when a drill bit should need replacing and when it should be necessary to trip-out the drill string to replace the drill bit.

The example plan described herein relates to the steps of drilling a number of stands and scheduling appropriate trip-out operations at the necessary times. This takes the drilling rig from the construction state illustrated in FIG. 1 to the construction state illustrated in FIG. 2, and on further to drill further stands, stopping for trip-out operations as necessary.

In order to get the system from the construction state illustrated in FIG. 1, to the second construction state illustrated in FIG. 2, it is necessary for a controller to carry out a part of a plan. Plans can be developed manually by a user, or automatically by a computer based planner. In the present disclosure, plans are created by an automated planning system, to have the plan structure described and disclosed herein.

The automated planner develops a plan for execution by a controller, while the plan of the present disclosure builds greater independence and flexibility into the plan than prior planning systems. Prior automated planning systems generally create a list of tasks to be completed at particular times, possibly incorporating certain preconditions for a set action to be executed, but no flexibility in when an action can be started is defined in prior plans. This means that if a certain task is not completed by the defined time for the next task to take place, then the plan is deemed to have failed and re-planning is necessary. The plan according to the present disclosure defines, for events in the plan, a set of preceding events, a set of following, or successor, events and at least one condition to detect the event having occurred or to authorise an action to be begun.

Time is not a determining factor in the plan of the disclosure and the plan is executed based upon event interdependencies and detected conditions without defining event start times, end times or durations in a prescriptive manner. As will become apparent from the following description, the plan executed in accordance with the method of the present disclosure is time independent and can therefore be executed based purely upon logical constraints and both planned and executed incorporating flexibility of time and resources available to carry out the actions in question.

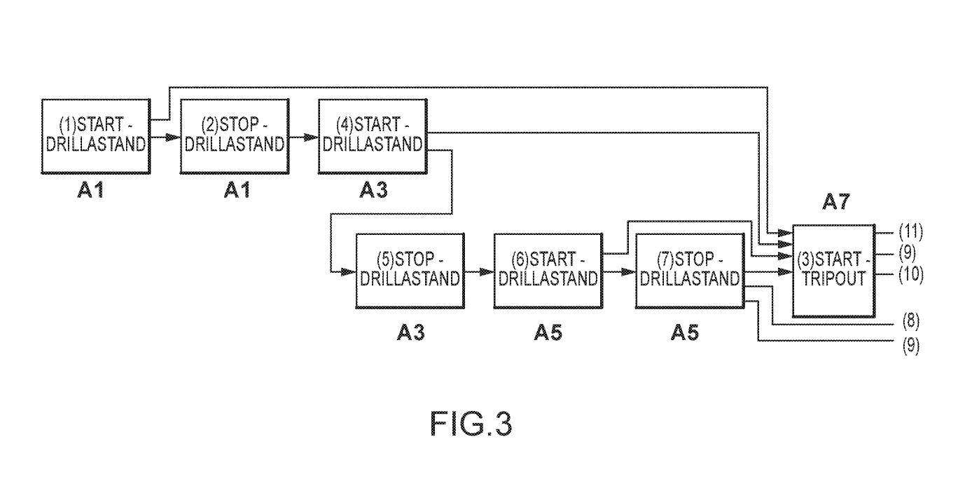

Turning to the simple plan of the illustrated example, beginning in FIG. 3, the plan starts with event #1, which is a drillastand event. It has successors 2 and 3, meaning that events numbered 2 and 3 (all event numbers are illustrated in the Figures in parentheses) and since it is the first event it has no predecessors. For the event #1 there is also identified an action number, in this case action #1, denoted on the figures as A1, and an action name, in this case DrillAStand. A parameter can also be set for the action and in this case, the parameter is set as ROP High, indicating that the controller should aim to achieve a high rate of penetration.

Further, preconditions can be set for the execution of an event and, in this instance, the preconditions are, firstly, that the drill bit is securely on the bottom of the well, defined by the Authorising Precondition ‘onbottom’. This can be detected, for example, by pressure sensors in the drill head, by sensing tension in pulleys supporting the drill string, or in other supporting structures of the drill string. A further precondition is that the system is not currently drilling, defined as ‘notcurrentlydrilling’, which can be detected by an output from the drill motor, torque sensors, or other suitable means.

These parameters for event #1 are summarised in Table 1 and further events will be described in a similar manner in relation to similarly formatted Tables, which are numbered according to the event number to which they relate, rather than being numbered consecutively, for ease of cross-referencing to the figures.

TABLE
Event #1

| | |
|---|---|
| Event # | 1 |
| Successors | 2, 3 |
| Predecessor | — |
| Action # | 1 |
| Action Name | DrillAStand |
| Parameter | ROP High |
| Authorising Precondition(s) | onbottom; notcurrentlydrilling |
| Failure condition(s) | failedcondition(onbottom) |

Event #1 therefore starts the drillastand process and so in response to Event #1 the controller begins a drillastand procedure. The example shown is simplified for ease of reference and conciseness, but in a practical implementation, further steps may be present in the plan. Examples of such further steps are instructions to the controller to start pumps for the mud in the drill string, and a check to verify that the drill string is released from slips before drilling, and any other checks or procedures necessary to permit drilling to begin. Where the order of events is not critical, the plan can define this in its structure. For example, the events in the plan defining how the action of checking the string is not in slips and starting the pumps may be given the same predecessors and successors as one another and may be given the same authorising preconditions. This allows the controller to simply ensure that the same preceding events have occurred before executing either or both of the events for checking the string is not in slips and starting the pumps. The plan therefore defines no order or execution for such ‘parallel’ events and the controller is free to execute them at any point in time and in any order to achieve the state necessary to start the drillastand operation.

An example of a failure condition may be defined by a parameter which must stay true for the action entailed by the event to validly continue. This can be defined as a failed condition—i.e. a condition which can directly indicate that the event has failed, and potentially that the overall plan has failed. As an example, Event #1 described in Table #1 above, can have a failed condition set as ‘onbottom’, since for the drillastand operation to validly continue it is imperative that the drill bit is detected as being on the bottom of the hole.

Event #2 in the plan has successor 4 and predecessor 1. The action number is 1 and a confirming condition is set as notcurrentlydrilling. This event therefore confirms that drill-a-stand has stopped, by detection that the system is not currently drilling. Its parameters can be summarised in the following Table 2.

TABLE 2

| | |
|---|---|
| Event # | 2 |
| Successors | 4 |
| Predecessors | 1 |
| Action # | 1 |
| Action Name | — |
| Parameter | — |
| Confirming Condition(s) | notcurrentlydrilling |
| Failure condition(s) | Exceededtime (mintime, maxtime, Event#1) |

A physical situation which can cause the controller to know that the drillastand operation is complete is that the drilling block mounted to the top of the stand being drilled will reach its bottom point, this can confirm that the stand has been fully drilled into the ground and so the plan allows for detection of this in Event #2. No time constraint is placed on event #2, but the conditions are that for it to occur, Event #1 must have occurred and notcurrentlydrilling is detected. A further check for validity of event #2 can be included in a second example of a failure condition. This can be a time based failure condition and can define a valid time window in which Event #2 can be detected to have occurred, in relation to Event #1. If the event has either occurred outside the expected time window (i.e. too early), or has not occurred by the end of the expected time window (i.e. is too late), then the action can be deemed to have failed. For example, knowing an expected rate of penetration (ROP), and a given length of the stand, an expected time for completion of the drillastand operation can be defined in the plan, as T(stand). However, it may be deemed acceptable by the planner that the time T(s) can be plus or minus a certain margin either side of the expected time T(s), so the actual time can validly be as low as a minimum time (mintime), defined as T(s) minus T(undertime). The actual time may also be as high as a maximum time (maxtime) defined as T(s) plus T(overtime). This can be defined as a specific type of failure condition and is expressed in relation to the event based upon which the time limits are set. A suitable syntax is shown in Table 2 above. The time restriction is therefore set as a range of acceptable times within which the event may validly occur in relation to one or more preceding events.

Event #4 is a further drillastand operation and has the predecessor 2 and successors 5 and 3. Its action number is set as 3, for future events to refer to, and the action name is drillastand. As for the event #1, event #4 sets the rate of penetration for the second stand to high, and starts on condition that the drill bit is on the bottom of the well and the system is not currently drilling. The failed condition onbottom applies as before for event #1. The parameters can be summarised as shown in Table 3 in the following:

TABLE 4

| | |
|---|---|
| Event # | 4 |
| Successors | 5, 3 |
| Predecessor | 2 |
| Action # | 3 |
| Action Name | DrillAStand |
| Parameter | ROP High |
| Authorising Precondition(s) | Onbottom; notcurrentlydrilling |
| Failure condition(s) | failedcondition(onbottom) |

Similarly for event #2, event #5 signals the end of the drillastand action of the second stand, begun in event #4, with the following parameters.

TABLE 5

| | |
|---|---|
| Event # | 5 |
| Successor | 6 |
| Predecessor | 4 |
| Action # | 3 |
| Action Name | drillastand |
| Parameter | — |
| Confirming Condition(s) | Notcurrentlydrilling |
| Failure condition(s) | Exceededtime (mintime, maxtime, Event#4) |

Event #6 starts a new drillastand action with a low rate of penetration. The choice of rates of penetration for each stand is determined at the planning stage. Drill bit wear is also approximately known from empirical data and previous usage. The planner can therefore be configured to incorporate into the plan a suitable selection of rates of penetration for the multiple stands which are drilled so that the bit wear does not reach zero mid-way through the drilling of a stand. This is advantageous, because the trip-out procedure, as described above, is a lengthy and expensive procedure, so it is preferable to have it occur at a point at the end of a drillastand action. Otherwise the trip-out action requires removal of the last stand and its reinsertion part way through a drilling action, which is inefficient. Therefore, the planner has set, in this example, the third stand to be drilled at a low rate of penetration (ROP) to preserve the drill bit to the end of the stand. Again, no time constraints need be set on when the stand starts, it is simply defined as occurring after the preceding events, as defined in Table 6.

TABLE 6

| | |
|---|---|
| Event # | 6 |
| Successors | 7, 3 |
| Predecessor | 5 |
| Action # | 5 |
| Action Name | DrillAStand |
| Parameter | ROP Low |
| Authorising Precondition(s) | On bottom; notcurrentlydrilling |
| Failure condition(s) | failedcondition(onbottom) |

Event #7, defined in table 7, monitors for the end of the drilling of the third stand in event #6, as was done for the preceding events #2 and #5.

TABLE 7

| | |
|---|---|
| Event # | 7 |
| Successors | 3, 8, 9 |
| Predecessor | 6 |
| Action # | 5 |
| Action Name | — |
| Parameter | — |
| Confirming Condition(s) | notcurrentlydrilling |
| Failure condition(s) | Exceededtime (mintime, maxtime, Event#6) |

A scheduled trip-out action is set to be executed once event #7 is complete, as defined in Table 3 below.

TABLE 3

| | |
|---|---|
| Event # | 3 |
| Successors | 10, 11, 9 |
| Predecessors | 1, 4, 6, 7 |
| Action # | 7 |
| Action Name | Tripout |
| Authorising Precondition | Onbottom |

Event #3 allows a trip-out of the drill string to be carried out after events 1, 4, 6 and 7 have been completed. This trip-out will be triggered by the drilling of the third stand being complete, as dete4cted in Event #7.

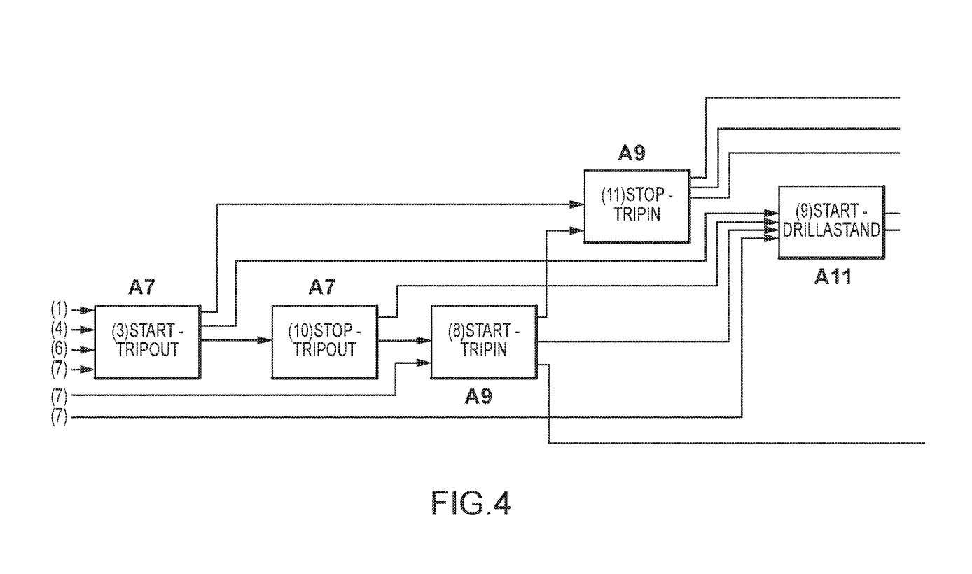

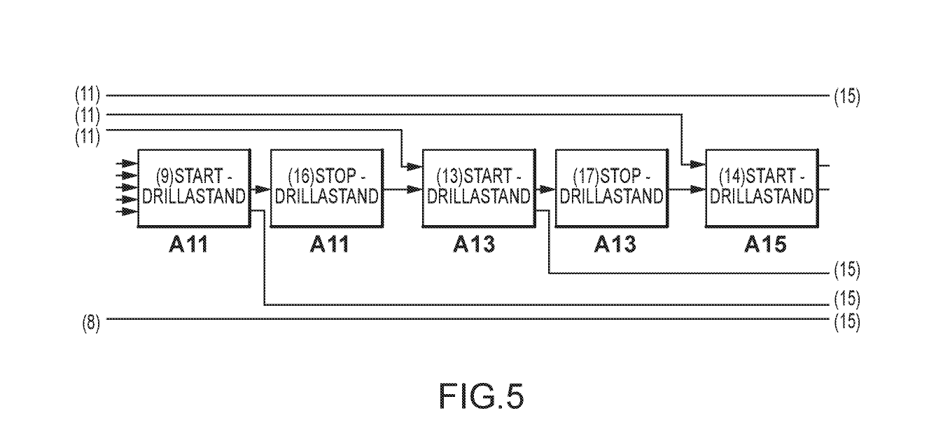

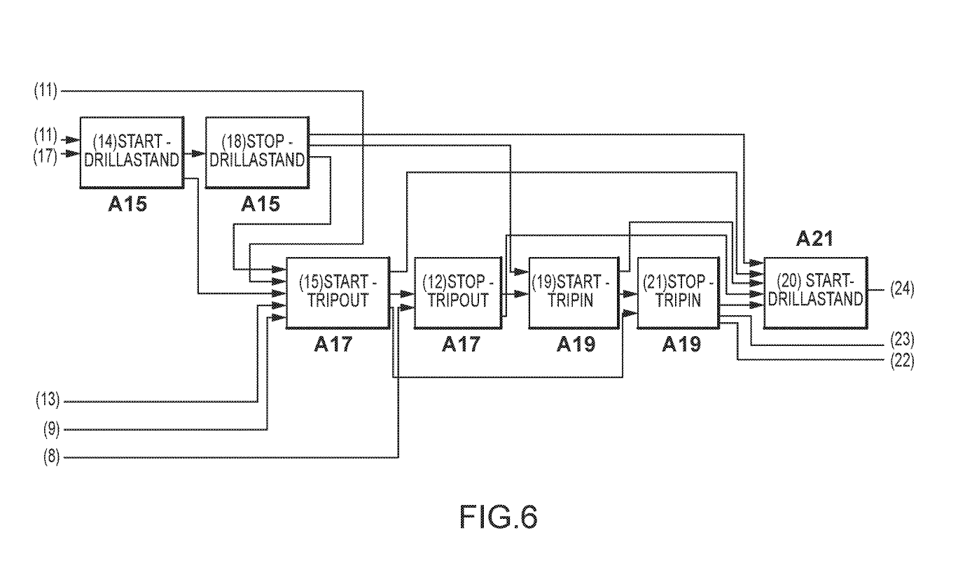

FIG. 4 illustrates further events defined in the example plan. As can be seen so far, the actions are authorised by authorising conditions, while a state of the system or world in which the system exists is detected and confirmed by a confirming condition and these conditions can be continuously monitored to allow the system to detect failure of actions based upon monitored parameters as the ‘failed conditions’ described above. This allows the plan to be executed based upon detected conditions, without necessarily having to rely on absolute time information.

After event #3, FIG. 4 continues with the following events as set out in the following tables, numbered according to their event number:

TABLE 10

| | |
|---|---|
| Event # | 10 |
| Successors | 8, 9 |
| Predecessor | 3 |
| Action # | 7 |
| Action Name | tripout |
| Parameter | currentbitwear = 0 |
| Confirming Condition(s) | atsurface |

Event #10 stops the trip-out process and resets the current bit wear to zero when it has been detected that the drill bit is at the surface and has been changed, so that the bit wear on the drill bit can now be considered to be zero.

Event #8 then begins the trip-in process, as defined by the following conditions and precedents:

TABLE 8

| | |
|---|---|
| Event # | 8 |
| Successors | 11, 9, 12 |
| Predecessors | 7, 10 |
| Action # | 9 |
| Action Name | tripin |
| Parameter | — |
| Authorising Precondition | atsurface |

Event #11 stops the trip-in, which must happen after the trip-out has been started and then stopped, and once the trip-in started, and defines this with the following information in table 11.

TABLE 11

| | |
|---|---|
| Event # | 11 |
| Successors | 9, 13, 14, 15 |
| Predecessors | 3, 8 |
| Action # | 9 |
| Parameter | — |
| Confirming Condition(s) | onbottom |

The trip-in is therefore stopped when the confirming condition that the drill stand is on the bottom of the well is detected.

Event #9 then restarts the drilling process with a new drillastand action, as defined in the following in table 9

TABLE 9

| | |
|---|---|
| Event # | 9 |
| Successors | 16, 15 |
| Predecessors | 7, 3, 10, 8, 11 |
| Action # | 11 |
| Action Name | DrillAStand |
| Parameter | ROP High |
| Authorising Preconditions | Onbottom; notcurrentlydrilling |
| Failure condition(s) | failedcondition(onbottom) |

The end of drillastand action 11, begun in event #9, is detected in event #16 by detecting a state of not currently drilling as defined in the following table 16

TABLE 16

| | |
|---|---|
| Event # | 16 |
| Successor | 13 |
| Predecessor | 9 |
| Action # | 11 |
| Action Name | DrillAStand |
| Parameter | — |
| Confirming Condition(s) | Notcurrentlydrilling |
| Failure condition(s) | Exceededtime (mintime, maxtime, Event#11) |

Event #13 starts a further drill-a-stand operation once the drillastand operation of action 11 has completed, as detected in event 16, as defined in the following table 13.

TABLE 13

| | |
|---|---|
| Event # | 13 |
| Successors | 17, 15 |
| Predecessors | 11, 16 |
| Action # | 13 |
| Action Name | DrillAStand |
| Parameter | ROP High |
| Authorising Preconditions | Onbottom; notcurrentlydrilling |
| Failure condition(s) | failedcondition(onbottom) |

The end of drillastand action 13, begun in event 9 is detected at event #17 as defined in Table 17 below.

TABLE 17

| | |
|---|---|
| Event # | 17 |
| Successors | 14 |
| Predecessor | 13 |
| Action # | 13 |
| Parameter | — |
| Confirming Condition(s) | Notcurrentlydrilling |
| Failure condition(s) | Exceededtime (mintime, maxtime, Event#11) |

As for the earlier set of drillstand actions, event #14 begins a new drill-a-stand action at a lower rate of penetration, using the following parameters, to preserve drill bit life until the next scheduled trip-out as in Table 14 below.

TABLE 14

| | |
|---|---|
| Event # | 14 |
| Successors | 18, 15 |
| Predecessors | 11, 17 |
| Action # | 15 |
| Action Name | DrillAStand |
| Parameter | ROP Low |
| Authorising Preconditions | Onbottom; notcurrentlydrilling |
| Failure condition(s) | failedcondition(onbottom) |

Event #18 detects the end of the end of the drill-a-stand action begun in event #14 by the following conditions defined in table 18 below.

TABLE 18

| | |
|---|---|
| Event # | 18 |
| Successors | 15, 19, 20 |
| Predecessor | 14 |
| Action # | 15 |
| Parameter | — |
| Confirming Condition(s) | notcurrentlydrilling |
| Failure condition(s) | Exceededtime (mintime, maxtime, Event#14) |

A further trip-out operation is then started at event #15, with conditions defined as in the following table 15.

TABLE 15

| | |
|---|---|
| Event # | 15 |
| Successors | 12, 21, 10 |
| Predecessors | 11, 9, 13, 14, 18 |
| Action # | 17 |
| Action Name | Tripout |
| Parameter | — |
| Authorising Precondition(s) | Onbottom |

The trip-out process is stopped, as previously in event #12, and the current bit wear is reset to zero once it is detected that the drill stand is at the surface, as for the previous trip-out in the following:

TABLE 15

| | |
|---|---|
| Event # | 12 |
| Successors | 19, 20 |
| Predecessors | 18, 15 |
| Action # | 17 |
| Parameter | Currentbitwear = 0 |
| Confirming Condition(s) | atsurface |

Therefore, the trip-out operation is stopped when it is confirmed that the drill bit has reached the surface. The current bit wear is reset to zero, since a new drill bit will have been applied with zero wear at the surface. Automated checks of the drill bit replacement can also be incorporated into the plan or into the controller.

Next, in event #19, the trip-in operation is started, followed by the stopping of the trip-in operation at event #21 and a new drillastand operation is started at event #20. This is defined in the same way as for the preceding equivalent actions in the following tables.

TABLE 19

| | |
|---|---|
| Event # | 19 |
| Successors | 21, 20 |
| Predecessors | 18, 12 |
| Action # | 19 |
| Action Name | tripin |
| Authorising Precondition(s) | atsurface |

Detecting end of trip-in by confirmation of onbottom condition:

TABLE 21

| | |
|---|---|
| Event # | 21 |
| Successors | 20, 22, 23 |
| Predecessors | 15, 19 |
| Action # | 19 |
| Action Name | tripin |
| Confirming Condition(s) | Onbottom |

As before, once it is detected that the drill bit is on the bottom of the well and it is detected that drilling is not currently underway, then the drillastand action is started in event #20 as set out in Table 20 below.

TABLE 20

| | |
|---|---|
| Event # | 20 |
| Successor | 24 |
| Predecessors | 18, 15, 12, 19, 21 |
| Action # | 21 |
| Action Name | DrillAStand |
| Parameter | ROP High |
| Authorising Precondition(s) | onbottom; notcurrentlydrilling |
| Failure condition(s) | failedcondition(onbottom) |

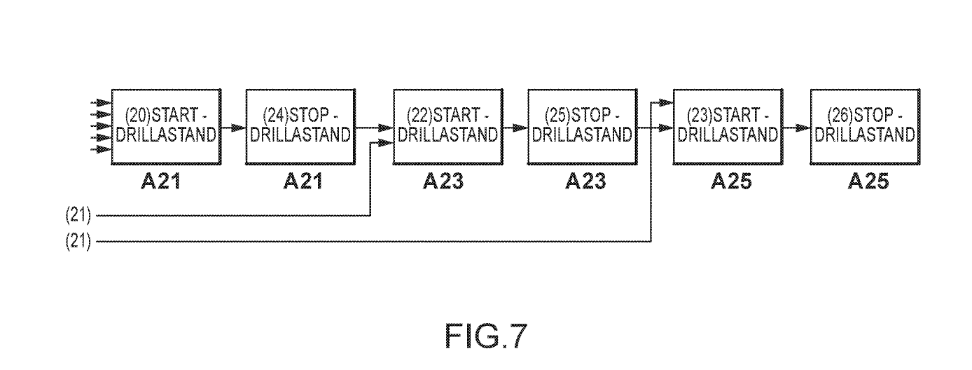

In subsequent steps, event #24 detects a stopping of drill-a-stand action 21. Then, a further drill-a-stand action 23 can be started in event #22, with the end of that being detected at event #25. Event #23 can then restart a low rate of penetration drillastand action, to reach the end of the operation, which is detected by event 26 at the end of FIG. 7, as is defined in the following tables.

TABLE 24

| | |
|---|---|
| Event # | 24 |
| Successor | 22 |
| Predecessor | 20 |
| Action # | 21 |
| Action Name | DrillAStand |
| Parameter | — |
| Confirming Condition(s) | Notcurrentlydrilling |
| Failure condition(s) | Exceededtime (mintime, maxtime, Event#20) |

In event #22 a high penetration rate drilling operation is therefore begun.

TABLE 22

| | |
|---|---|
| Event # | 22 |
| Successor | 25 |
| Predecessors | 21, 24 |
| Action # | 23 |
| Action Name | DrillAStand |
| Parameter | ROP High |
| Authorising Precondition(s) | onbottom; notcurrentlydrilling |
| Failure condition(s) | failedcondition(onbottom) |

Event 25 detects the end of the high rate of penetration drill-a-stand operation of action 23, begun in event #22.

TABLE 25

| | |
|---|---|
| Event # | 25 |
| Successor | 23 |
| Predecessor | 22 |
| Action # | 23 |
| Action Name | DrillAStand |
| Parameter | — |
| Confirming Condition(s) | notcurrentlydrilling |
| Failure condition(s) | Exceededtime (mintime, maxtime, Event#22) |

A low rate of penetration drill-a-stand event is then begun to finish the stand in event #23 as follows:

TABLE 23

| | |
|---|---|
| Event # | 23 |
| Successor | 26 |
| Predecessors | 21, 25 |
| Action # | 25 |
| Action Name | DrillAStand |
| Parameter | ROP Low |
| Authorising Precondition(s) | onbottom; notcurrentlydrilling |
| Failure condition(s) | failedcondition(onbottom) |

Finally, the end of the drillastand action number 25 is detected in event 26 and the plan can be deemed to have been completed.

TABLE 26

| | |
|---|---|
| Event # | 26 |
| Successor | — |
| Predecessor | 23 |
| Action # | 25 |
| Action Name | DrillAStand |
| Authorising Precondition(s) | Notcurrentlydrilling |

As can be seen from the preceding description, the execution of the various actions is governed only by logical connections between the events scheduled in the plan and by preconditions which are detected or not detected, either at the beginning of, or during, the execution of certain actions.

The controller executing the plan defined herein therefore reads the entirety of the plan and can execute it based upon the logical connections and preconditions set out in steps in the plan which are governed by events.

During the planning stages, the balance of a number of expected trip-out operations versus an ideal rate of penetration can be set. Here additional external solvers may be employed to define when during the process a trip-out operation is best scheduled. Constantly drilling at a higher rate of penetration will result in more trip-outs, since the rate of wear will be higher. Complete extraction of the drill string to carry out the trip-out operation to replace the drill bit is a costly and time consuming exercise and so it is generally desirable to minimise these operations. This is why the planner may consult external solvers, which can inform the planner of the best rate of penetration to choose for different parts of the drilling operation to ensure an optimum rate of penetration, with a minimal number of trip-outs and drill bit changes.

As described above, the plan structure and methods of execution defined herein can be utilised in other areas of well construction and maintenance. The actions may also relate to the well completion process, and could be sequenced events for inserting chosen casings, any part of the well cementing process, activating perforating means such as bullet or jet perforators and other related actions. The actions may relate specifically to parts of the cementing process and can include actions such as casing insertion and packing, pumping of the cement, top and bottom wiper plug insertion, wiper plug release and related pumping. The actions may further relate to wireline operation and so can relate to the insertion or retraction of tooling or maintenance apparatus from the well by wireline.

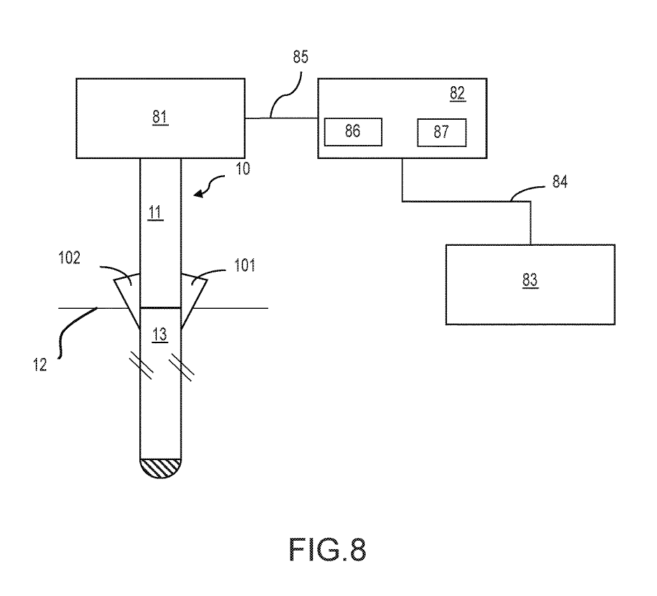

FIG. 8 shows an apparatus for carrying out the methods of the disclosure. In addition to the same-numbered features described in relation to FIG. 1, the system comprises a drilling block 81, which can be equipped with a motor to drive the drill string, sensors to detect the drilling action, pumps and other components as used in well-known drilling block assemblies. The block is attached to a controller 82 by a controller connection 85, which may be a wired or wireless data connection. Controller 82 is equipped with controller means which are configured to execute the steps in the methods described herein, by carrying out the steps defined in the plan described in the above sections. A storage medium 87 may be equipped with the plan and the storage medium 87 may be read to a processing device 86, which may execute the plan as described above.

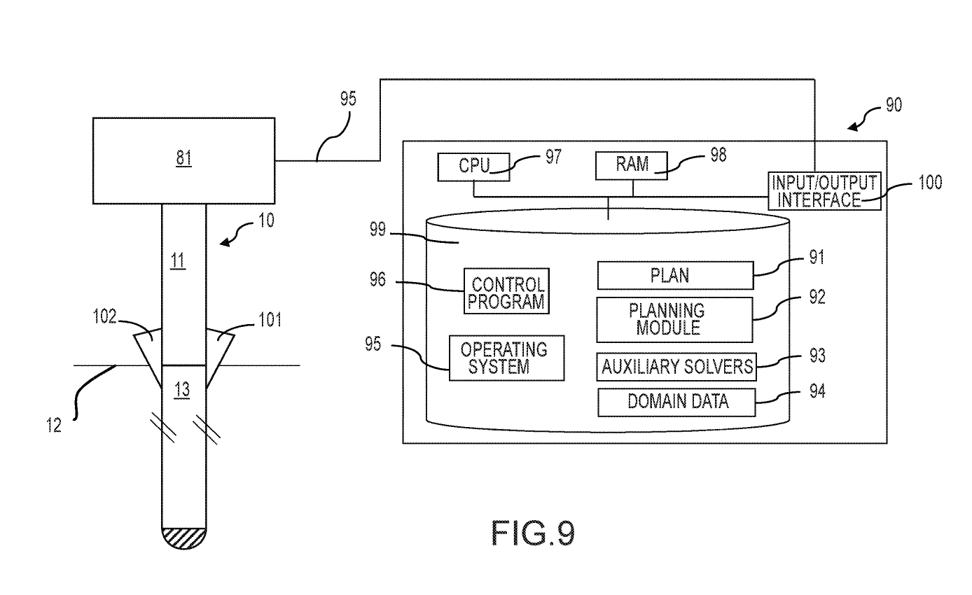

FIG. 9 shows a computing device 90 which can also be used to implement an apparatus for carrying out the methods of the present disclosure. The computing device 90 is connected to the well construction equipment 10 via a data link 95, which may be a wired, fibre, other physical data link or a wireless data link. The data link is connected via and input/output interface 100 of the device 90. The computing device 90 has a Central Processor Unit (CPU) 97, live memory or Random Access Memory (RAM) 98 and a computer readable medium such as a solid-state disk hard-disk or flash memory device 99 or the like. Stored on the memory 99 are a series of programs and data sets configured for executing the methods of the present disclosure. An operating system 95 carries general operating instruction for the computing device. A control program 96 carries instructions which, when read by the processor 97 cause the processor to be configured to read a plan 91 stored in the device 90 to carry out the methods described herein. A planning module 92 may also be included, to allow the device 90 to create plans for the controller module to execute as necessary. Auxiliary solvers may be included, to carry out certain auxiliary processing functions, such as the determination of bit wear vs. rate of penetration discussed in the present disclosure, during the planning procedure. Domain data may be stored, which can be fed to the planner and/or the controller in order to allow the plan to be developed and executed with an awareness of the parameters associated with the construction domain in question. The described system therefore provides a computer program 96 comprising instructions which, when executed by the processor 97, cause the processor to be configured to carry out any of the methods described herein.

A plan of the preferred embodiment can in practice be coupled with an operational file. The operational file can contain operational data about each of the available actions in the domain for which the planning is being carried out, such as the well construction domain of the examples described above. Information contained in a domain file is not repeated in the operational file. The domain file is set out in a PDDL (Planning Domain Definition Language)-based language and contains definitions of the environment in which the operation is taking place, in a manner known to those skilled in the art of planning domain definition. This PDDL-based model of the domain contains a deterministic model of the behaviour of system in the domain, under an assumption of complete knowledge of the initial state of the system and domain prior to plan execution. This deterministic definition means that, for known initial states and known inputs, repeatable output states are always achieved, with no randomness involved, so outcomes are therefore predictable.

Many of the execution conditions that affect success or failure of the execution of an action are external to the PDDL planning domain model. For example, in well construction, the Bottom Hole Assembly (BHA) might be considered stuck if the drill string has not rotated for several seconds, but the necessary sensing actions are not captured in the domain description because it only describes deterministic behaviour, without uncertainty. The planner uses an abstract model of how the plan will interact with the world, and execution failures can be expected unless the gap between the PDDL model and the sensed world is bridged. The operational file can help achieve this as follows.

The preferred embodiment includes the definition of the structure of the “operational file”. The operational file supplements the domain definition file with information that is required during execution. This includes, for example, whether durative actions end with controllable or uncontrollable events (as are described in more detail in the following) and a description of failure conditions or events that are not described in the PDDL model. This allows the plan to cater for non-determinism in a way in which the PDDL model itself does not. The operational file bridges the gap between the domain model and the real world situation in place during execution by specifying control parameters. The control parameters include monitoring conditions, such as timeouts, and any other monitoring conditions that are not modelled in the domain file. The domain designer specifies the operational file alongside the domain file and a problem file specifying the problem, prior to creation of a plan. The operational file therefore contains operational data about each of the actions executed in the domain. It does not repeat information in the domain file, but instead provides additional information, in particular information relating to the authorisation, confirmation and timeout conditions.

The operational file in the preferred embodiment is given as an input to a planner and the information in the operational file is merged with the plan when the plan is generated, instantiated according to the final structure of the plan. This means that the final plan created for execution comprises operational data input from the operational file, which can increase the execution robustness of the plan and can allow the plan to cater for changes in the system state, experienced during execution of the plan, which are not catered for in the deterministic PDDL model of the domain.

For example, in the example of well construction, and a drilling operation in particular, the domain file can contain values or definitions representing the significance of soil conditions, rock formations and other geographical or seismic factors, which would influence the planning operation and which are generally repeatable and predictable. Specific instantiations of a rock formation property, however, are included in the specific problem definition for a particular planning exercise.

Properties and conditions specific to particular actions can be defined in the operational file. In the preferred embodiment, each action defined in the operational file has a name, a start and an end. The properties of the start of an action and the end of an action may be either identical or symmetrical, because the end of an action contains a confirming condition as defined above and the detection of the confirming condition, which would end the action, is not necessarily within the control of the planner. On the contrary, the planner is always able to control the start of an action in a plan.

The action start may have a timeout defined in the operational file, specifying the minimum time that must elapse after all the authorising preconditions have been met. This could be a zero value, and defines the amount of time which must have elapsed after those authorising preconditions are detected as having been met before the start of an action can be executed by the controller. There can also be defined a maximum time by which the start must have occurred. If the maximum timeout has been exceeded then the start of that action can be deemed to have failed.

The start of an action can also be deemed to have failed by the detection of conditions, i.e. failure conditions, which are not defined in the domain model, but which are defined in the operational file. These failure conditions would deem the action to have failed at the time of its execution. A failure condition, as described above, is given an attribute of an exceeded time, describing the minimum amount of time for which the failure condition should be observed before the plan is deemed to have failed, and also a maximum time that can have elapsed before the failed condition must be deemed to fail the action, and therefore potentially to fail the plan as a whole.

For example, the failed condition (e.g. onbottom) defined above can also be associated with an exceeded time failure condition, in combination, so that it defines a minimum amount of time during which the failed condition (e.g. onbottom) must be observed (i.e. a lack of the drill bit being on the bottom) before the plan fails. This allows for a brief instance of the drill bit not being on the bottom, without failing the whole plan if it is corrected quickly. The maximum time can also be defined to set a maximum amount of time which can pass before the detection of the failure condition (e.g. onbottom) must be addressed and no longer ignored. Action ends can be controllable, by defining the end of an action as being triggered in response to a command sent from the controller. For example a drilling action can be defined such that an end of the drilling action is triggered by a command from the controller to stop the drilling block from moving. This is an example of a controllable action end. Alternatively, action ends can be uncontrollable and these uncontrollable ends are simply confirmed by detection of a confirming condition, such as notcurrentlydrilling, as defined in the example plan above. An example is where a drilling command implemented in the controller sets the block to move by a set distance. In this instance, the end of the action is defined by the system detecting that the block has moved by the distance set. The end of the action is therefore not controlled by the controller, but is set to automatically occur on detection of the set distance being reached. From the perspective of the controller, the action end is automatically instigated by the system, based upon the way in which the event was defined. The end of an action can also have a continuous effect and in this case the end of the action is not controllable by the planner. The continuous effect in the example of a plan described herein could be one of “depth reached”, which is the effect of a ‘drillastand’ action reaching the necessary depth. Observation of this attribute confirms the end of the drilling action. If the end of an action is controllable, such as in the case of the trip-out action, it may be authorised by any specific preconditions which have been defined, such as detection of the drill bit being at the surface.

While the majority of the above description focusses on the structure of the plan and how a controller executes the plan, the following describes some further details of how a planner or planning module or modules can act to create a plan for execution by the controller which will carry out the plan.

The task of an automated planner is to construct the plan to achieve the end well construction goal, such as that of drilling a stand described above, based upon a set of initial conditions and using actions available to it as defined in the description of the domain in which the plan will be executed. The plan output produced by the planner in the present disclosure aims to contain sufficient information to identify what conditions must be met for it to be deemed an action has either failed or succeeded. This can be achieved by inclusion in the plan of the authorising preconditions, the confirming conditions and the failure conditions all described above. These can generally be termed monitoring conditions. The aim of the present disclosure is therefore to enable to output of a plan in a form that can be interpreted and executed based upon the defined predecessors and conditions.

To enable this, a planner of the present disclosure can be configured to present a plan structure, comprising the information described above and in the following. The plan can be described as a list of events, where each event is either a start of an action or an end of an action and each has associated with this a collection of conditions or constraints. As is described above, the plans of the disclosure are temporally flexible and, as long as the constraints defined in relation to each event are complied with, each event can be executed or deemed complete at any point in real time. A plan of the disclosure can be delivered as an XML file, which provides a suitable structure for describing the necessary interrelationships, actions and constraints and which can, with suitable interpretation software, be viewed graphically as shown in the figures to assist a user or operator of the planning system to view the output graphically. This can enable the execution of a plan to be monitored by a monitoring individual in real time and it is also possible for minor adjustments to be made to the plan without a full re-planning of the entire activity for reaching the goal having to occur.

In a practical implementation of a well construction system, there are a number of influencing factors on the planner. There are the physical and geographical constraints which form part of the domain model. Further, there are the motivations of individuals or other external systems, which are either in control or have an influencing effect on the procedure, such as the driller, a directional driller and a “company man” having a more commercial, cost focussed and/or safety-focussed view of the procedures. In the present disclosure, the desires of humans involved in a well construction planning procedure can be modelled as motivations that will influence the goal of the dynamic planner as it creates the plan. To deal with multiple desires, each motivation from each of these users is assigned a weight, based upon its perceived criticality in the well construction process in question. A desire having a low level of criticality may be a desire to finish a drilling stand, while a desire having a higher level of criticality may be a desire to mitigate an impending kick. A kick is a general term for a flow of formation fluids into the wellbore during drilling operations. The kick is physically caused by the pressure in the wellbore being less than that of the formation fluids, thus causing flow. This condition of lower wellbore pressure than the formation is caused in two ways. First, if the mud weight is too low, then the hydrostatic pressure exerted on the formation by the fluid column may be insufficient to hold the formation fluid in the formation. This can happen if the mud density is suddenly lightened or is not to specification to begin with, or if a drilled formation has a higher pressure than anticipated. This type of kick might be called an underbalanced kick. The second way a kick can occur is if dynamic and transient fluid pressure effects, usually due to motion of the drill string or casing, effectively lower the pressure in the wellbore below that of the formation. This second kick type could be called an induced kick.

Other motivations can be included, which may be based upon a symbolic interpretation of rig measurements made both down-hole locations and at the surface. These can be used to express a probabilistic view of the world state that typically cannot be embedded in the domain description. In one example, a bayesian network can be configured to find a probability of an unwanted occurrence such as a kick described above. For example, if the bayesian network infers a probability of a kick above 0.5, then the motivation in the system is changed to ensure that an influencing variable, such as the flow in a drilling operation, is checked to mitigate the impending unwanted occurrence such as a kick. If the bayesian network infers a probability of the unwanted occurrence of a kick above 0.8, then the motivation may be changed to ensure that the mitigation procedure is started immediately.

Based upon the set of motivations determined, a goal for the dynamic planner can then be calculated, taking into account the various weighted motivations in order to model a calculated consensus between human desires and measured inputs taken by the system and its machinery and communicated to the controller, to determine what the common system goal should be, taking account of all of those weighted influencing inputs.

By using such a higher level of abstraction for the human machine interface, by use of this motivation modelling mechanism, direct influence of human operators on the system can be excluded, to ensure that either inadvertent, or unnecessarily direct, intervention does not cause unnecessary re-planning and down-time for the well construction system in question. In this way, conflicts in motivations of humans and a controller executing the plan can be combined, so that human operators can participate in the decision making process, without breaking the essential constraints of the system being controlled.

These human motivations are, in one embodiment, included in the planning stage and so influence the plan created by the planner. This method of the present disclosure would allow, for example, a remote operator to alter the system goal and alter constraints (such as frequency of surveys). This can allow the planner, at planning time, to take into account the request and to schedule more frequent surveys at an appropriate point. However, this methodology would not allow the human to, for example, directly intervene by, e.g. switching down pumps on the rig, which is a common way to trigger a survey on certain drilling equipment.

Therefore, modelling human desires relating to a well construction process and defining these in the planning system as motivations can improve both the efficiency and safety of operation of a system when managing inputs from both known measured parameters and human operators.

The planning system of the present disclosure goes through a decision-making process in order to assess various parameters, such as when steering operations should occur, usually defined by one or more depth markers at which depth a steering event should be triggered, rates of motion, and whether certain expectations exist, or should be taken into account, relating to how long an operation should take place. In the drilling domain, the decision-making process can involve calculations which are beyond the computational capacity of standard planning and execution engines. For efficient planning to take place, a single processor, set of processors, logical software module or separate computer device may be required for generally managing the planning procedure, while a separate processor, set of processors, logical software module or separate computer device may be required for running the execution engine. There may be limited resource available for dealing with complex calculations which are necessary in the planning procedures. The types of calculations which are potentially demanding on computational resources, and thus may need outsourcing to modules external to the planner itself, in the technical area of well construction, in particular in the drilling domain, include the calculation of depth markers for steering commands to be sent to down hole rotary steerable systems, the calculation of optimal weight-on-bit, or speed of rotation required to maximise a rate of penetration, or a correlation between rate of penetration, bit wear data, and a point at which total bit wear will be sufficient that a trip-out operation is necessary to replace the drill bit.

In the planning system of the present disclosure, these calculations may be delegated to external logical modules or processes, both at planning time in the planning process, and optionally also at execution time, in order to give the system the ability to update its recommendations during the execution procedure and potentially modify the existing plan based upon real time feedback, during the well construction or drilling process. Any or all of the above mentioned calculations can therefore be calculated by a process external to the planning engine. The relevant externally handled parameter can be associated with a unique identifier which is then carried through to the planning system, and which may also be used during the execution of the plan, so that the externally handled parameter can be taken into account during both the execution and planning processes. The parameter can therefore also be communicated back and forth, as necessary, to the external process handling that particular parameter. This procedure therefore provides a method of either initially producing a plan, or of updating a plan, in which detailed calculations of physical parameters relating to the real world implementation of the plan are delegated to external solvers, which external solvers are either logically or physically separate from the logical or physical process or equipment managing the planning and/or execution operations.

During the planning and/or execution phases of the methods of the present disclosure, standard operating procedures may be implemented using predefined macros of certain pre-selected actions. Dynamic planners are generally tasked with finding a solution to a search problem. For example, in well construction this could be the problem of drilling to a particular point, while trying to minimise a cost or reward function, such as time, or while trying to maximise a reward function, to reach the goal. Either minimising a cost function or maximising a reward function in the planning process can motivate the planner to select the desired events in the plan. Therefore, a cost or reward function can be improved or optimised to achieve the desired effect on the behaviour of the planner. The planner sequences individual events and schedules those events based upon this optimisation effort, but previously, there has not been provision for an efficient way of influencing the planner to choose predetermined sequences of actions for any, some or all of the procedure.

In well construction, particularly in the drilling domain, drilling operators often maintain well-defined standard operating procedures. This is often done because it may be known, for example, that certain sequences of events may be one or more of: lowest risk; a safest way of carrying out a procedure; part of a standard health and safety procedure; from which the planner should not deviate, even if a different sequence may appear more time or cost effective. It can therefore be advantageous to be able to influence the planner to follow such standard operating procedures. One way of doing so would be to change the set of actions available to a planner based on the drilling operator expected to be in charge of the operation, but this solution would not be easily scalable, since it would require a large number of changes to be made to the available actions each time there is a change of operator. If a set of actions must be changed each time there is a change of operator, then the large amount of actions which must be directly changed leads to a large number of combinations of different actions for different users. Each combination has to be tested and so this can lead to an inefficient validation testing overhead. These are therefore preferably avoided by the methods described above.

In the planning system of the present disclosure, a macro can be defined as comprising pre-defined subsets of actions, which the planner may be rewarded for choosing to incorporate into the plan. The reward function can be modelled in a number of known manners described above, such as by defining the planner's goal as being to maximise its reward and by allocating an increase in reward to the choice of the desired standard operating procedures, or conversely, where the goal is to minimise a cost function, such as time, the choice of the desired standard operating procedures may be rewarded by an additional reduction in the cost function.

By use of this procedure to encourage the planner to use such macros comprising pre-defined sets of actions, a principal advantage is that other actions, or lower level actions, are not unduly affected, and it is not necessary to include drilling-operator-specific definitions, parameters or procedures in the actions themselves. Rather, the macros define a set of specific actions, parameters for actions and/or sequences of actions, which are specific to any particular drilling operator. A further advantage of this type of process is that the remainder of the planning and related decision making system, such as the external physical solvers, do not need to be aware of the standard operating procedures, and neither does the controller executing the plan. Rather, the macros are simply incorporated into the plan, as macros made up of specific actions, with particular attributes and properties. The resulting plan therefore does not need to include explicit detail of what parts of the plan relate to the standard operating procedures, or indeed any direct reference to the standard operating procedures. Rather, the steps making up the standard operating procedures are broken down into operator-independent actions and implemented in the plan, so that the relevant parts of the plan correspond with the relevant standard operating procedures.

A further form of predefined event or sequence of events which may be either used during the execution of a plan, or incorporated into a plan according to the disclosure, is a pre-set plan, which can be used to force the system to achieve a predetermined state. In certain cases, particularly in the well construction domain, and more particularly in the drilling domain, it may be necessary to avoid resorting to dynamic planning, in order to reach a specific goal either quickly, safely or in a robust manner. This can be the case in particular for emergency procedures, where it is necessary to bring the system to a chosen goal state without carrying out analysis of how to get to the goal state, but rather following a pre-set procedure, which may include an emergency procedure. Rules can be defined for choosing a particular pre-set plan out of a set of chosen pre-set plans. For example, a pre-set plan may be a plan for shutting the well. A rule may be set to execute the pre-set plan for shutting the well when automatic system checks, such as self-consistency system checks, fail or fail a repeated pre-set number of times.

Such pre-set plans may be created from a sequence of the same events and actions as are used in plans created using the automated planner. However, the pre-set plans may be created with either fewer preconditions or parameters, or broader ranges set in those parameters, in order to make those plans more robust, i.e. reducing their likelihood of failure. For example, the plans may be executed to take into account a reduced number inputs, preconditions, failure conditions or minimum time and maximum time conditions, in order that they achieve the chosen goal in the quickest and safest manner possible. For example, an emergency action, such as one for lifting the drill string off bottom to avoid shocks or vibration, may be activated with, for example, no predecessors or successors defined, or ignoring any preconditions usually used, beyond the ‘onbottom’ pre-condition defined in the example of a plan described in the example above. A more significant emergency operation may be to shut the well, with a reduced set of predecessor events or preconditions set, or with none set in the extreme. Executing a pre-set plan having a set of conditions, parameters, successors and/or predecessors which is reduced compared to an event used in a plan created in the automated planning procedure can allow a procedure, such as an emergency trip-out, to be performed without hindrance by non-essential parameters defined for a standard event in a plan. To achieve this, one or more of: the list of any events in the plan which must precede the event; an action to which the event relates; and one or more of the at least one authorising precondition; the at least one confirming condition; and the at least one failure condition is configured to reduce its likelihood of causing the pre-set plan to fail.

The planning process carried out by the planning module can take varying amounts of time to execute, depending upon the complexity of the domain, the number of steps required to complete the necessary goal and what variety of actions and related parameters is required to achieve the goal. It can therefore be valuable to understand when it is advantageous to complete a planning step and when, on the contrary, the length of time required to complete the planning process may be too long to render the re-planning step useful.

In the system and method of the present disclosure, the length of the planning process can be monitored during each planning step and then statistics relating to the length of time required to complete the planning process, for a given external state and for a given goal, can be compiled. These data can then be compared with the existing state of the current goal-oriented activity, to determine whether there is any merit in completing the currently active re-planning operation. For example, if a planner has been carrying out a re-planning activity for an extended period of time, then the external state of the environment in which the controller is executing the plan may change during re-planning. This might then mean that as soon as the plan being compiled is commenced, it would fail in any case and immediate re-planning could be necessary as soon as planning is complete. The method of the present disclosure therefore allows the identification of whether the current planning process should be aborted, if a certain change in the external state of the environment in which the controller is executing the plan is detected. The re-planning process can then be started again based upon the new initial state, which is different from the original initial state used for the aborted re-planning step. Therefore, the system and method of the present disclosure can incorporate the storage of statistics relating to varying initial states, goals and the related times taken, or statistics on the times taken, to re-plan under a range of initial conditions and goals. It is therefore possible to compare statistics on performance of the planning procedure with the current initial and goal states and to use this to guide into the decision on whether to continue a re-planning step or to abort planning and restart the planning process from the new initial state.

It can be beneficial to retain an audit trail to determine how a combined planning and plan execution system has executed, re-planned and re-executed the new plan to achieve an eventual goal state. This can be particularly helpful if the system behaves in an unexpected manner, or if something goes wrong in the general operations being carried out by the system. Therefore, in the present disclosure, the system can be configured so that at every step in the planning, execution and re-planning procedure, the system records an initial state, a goal to be achieved and the resulting plans for one or more planning or re-planning steps of the procedure. This information can be stored on a storage medium, for example, in the planner, and can be used to feed either or both of an audit and traceability system which can be accessed by a user to determine exactly what planning, execution and re-planning steps have been carried out by the system and can further feed into statistical data stored in order to determine expected performance of the planning process, in terms of time to completion before particular initial states and goal states.

Although the disclosure has been described above with reference to one or more preferred embodiments, it will be appreciated that various changes or modifications may be made without departing from the scope of the disclosure, as defined in the appended claims. It will also be apparent that features of these different embodiments can be combined both with one another and also with features of the prior art arrangements described herein in order to achieve the advantages of the disclosure.

1-40. (canceled)

41. A method comprising:
defining a plurality of events in a plan which are to be carried out to change the state of a well from a first state to a goal state;
defining in the plan, for one or more of the plurality of events:
one or more other events in the plan which must precede the event;
an action to which the event relates; and
at least one condition for the event, selected from:
at least one authorising precondition;
at least one confirming condition; and
at least one failure condition.

42. A method according to claim 41, further comprising creating the plan while taking account of one or more input variables representative of a user desire.

43. A method according to claim 42, wherein the one or more user desires is/are allocated a weighting with respect to other inputs.

44. A method according to claim 42, wherein the plan accounts for a user desire by changing the goal to the user desire.

45. A method according to claim 41, wherein creating the plan comprises incorporating input, relating to calculated parameters of a well construction and/or operation procedure, received from one or more logically or physically separate processing modules.

46. A method according to claim 45, wherein the input taken from the separate processing modules relates to physical parameters of the domain in which the well construction and/or operation is planned to occur.

47. A method according to claim 45, wherein the input taken from the separate processing modules relates to one or more of: the calculation of depth markers for a steering command in a drilling operation; a calculation of an optimal weight on the drill bit for a desired rate of penetration.

48. A method according to claim 45, further comprising selecting events for inclusion in the plan from a set of events, the set of events including pre-defined macros comprising pre-defined sets of events relating to the well construction and/or operation procedure.

49. A method according to claim 48, wherein a cost or reward function is improved based upon the selection of one or more of the pre-defined macros.

50. A method according to claim 41, further comprising terminating the execution of the plan created by the automated planner and executing a pre-set plan to achieve a chosen goal.

51. A method according to claim 50, wherein:
one or more of:
the one or more other events in the plan which must precede the event;
an action to which the event relates; and
one or more of:
the at least one authorising precondition;
the at least one confirming condition; and
the at least one failure condition,
is either removed or disregarded or is configured with adjusted parameters, to reduce likelihood of causing the pre-set plan to fail.

52. A method claim 41, wherein:
data relating to a time taken for the planning procedure to complete are held in a memory; and
an external state of a system configured to execute the plan is monitored during a planning step; and
a determination is made as to whether to abort the planning step, based upon the data and a detection of a change in the external state of the system.

53. A method according to claim 52, wherein the data are based upon statistical analysis of previous performance of the planning procedure.

54. A method according to claim 52, wherein the data comprise expected planning times relating to one or more of: one or more chosen goals and one or more initial states of the system.

55. A method according claim 41, further comprising terminating execution of the plan on detection of a failure condition and establishing a revised plan based upon a new initial state of the well.

56. A method according to claim 41, wherein audit data are recorded for the plan creation procedure, the audit data comprising one or more of: an initial state, a goal and a resulting plan.

57. A computing system, comprising:
one or more processors; and
a memory system comprising one or more non-transitory, computer-readable media storing instructions that, when executed by at least one of the one or more processors, cause the computing system to perform operations, the operations comprising:
defining a plurality of events in a plan which are to be carried out to change the state of a well from a first state to a goal state;
defining in the plan, for one or more of the plurality of events:
one or more other events in the plan which must precede the event;
an action to which the event relates; and
at least one condition for the event, selected from:
at least one authorising precondition;
at least one confirming condition; and
at least one failure condition.

58. The computing system of claim 57, wherein creating the plan comprises incorporating input, relating to calculated parameters of a well construction and/or operation procedure, received from one or more logically or physically separate processing modules.

59. A non-transitory, computer-readable medium storing instructions that, when executed by at least one processor of a computing system, cause the computing system to perform operations, the operations comprising:
defining a plurality of events in a plan which are to be carried out to change the state of a well from a first state to a goal state;
defining in the plan, for one or more of the plurality of events:
one or more other events in the plan which must precede the event;
an action to which the event relates; and
at least one condition for the event, selected from:
at least one authorising precondition;
at least one confirming condition; and
at least one failure condition.

60. The computer-readable medium of claim 59, wherein creating the plan comprises incorporating input, relating to calculated parameters of a well construction and/or operation procedure, received from one or more logically or physically separate processing modules.
